(19) United States
(12) Patent Application Publication
(10) Pub. No.: US 2022/0189381 A1
(43) Pub. Date: Jun. 16, 2022

(54) OPERATION OF A DEVICE COMPRISING A LIGHT EMITTING DIODE

(71) Applicant: Telefonaktiebolaget LM Ericsson (publ), Stockholm (SE)

(72) Inventor: Alexander HUNT, Tygelsjö (SE)

(21) Appl. No.: 17/438,065

(22) PCT Filed: Mar. 28, 2019
(86) PCT No.: PCT/EP2019/057872

§ 371 Date: Sep. 10, 2021

(51) Int. Cl. G09G 3/32; G09G 5/10

(52) U.S. Cl. CPC G09G 3/32; G09G 5/10; G09G 2320/0686; G09G 2330/045; G09G 2320/041

(57) ABSTRACT

A method for operating a device comprising a Light Emitting Diode (LED) display is disclosed. The method, performed in the device, includes obtaining a representation of temperatures to which different areas of the display are subjected, generating a display heat map from the obtained representation, and managing the luminance of the different areas of the display on the basis of the display heat map. Also disclosed are a device and a computer program configured to carry out a method for operating a device.

### TECHNICAL FIELD

The present disclosure relates to a method for operating a device comprising a Light

Emitting Diode (LED) display, which may be an Organic LED (OLED) display. The present disclosure also relates to a device comprising a LED display and to a computer program product configured to carry out a method for operating a device comprising a LED display.

### BACKGROUND

Light Emitting Diodes (LEDs) are used in displays for a wide variety of electronic devices. Liquid Cristal Displays (LCDs), which are widely used in televisions as well as smaller electronic devices, typically use LEDs to provide the necessary backlight.

Such displays are particularly popular in electronic devices that are subject to functional restrictions in volume. Examples of such devices include wireless devices such as mobile phones or smartphones, headphones, watches, smart bands, Helmet Mounted Displays (HMDs), Heads-Up Displays (HUDs) etc. Organic LED (OLED) displays are increasingly being adopted in larger and smaller electronic devices, and offer certain advantages over conventional LCD displays with a LED backlight, including improved contrast and viewing angles. In contrast to conventional LCD displays, which use a LED backlight to illuminate pixels, each OLED pixel produces its own light, with an OLED display being formed from an array of individual red, blue and green OLEDs. The light of an OLED display can therefore be controlled on a pixel-by-pixel basis. Micro-LED based displays are also in development, and operate on a similar principle to OLED displays, with individual micro-LED pixels producing their own light, and display formed form an array of red, blue and green micro-LEDs.

All types of LED display are sensitive to temperature, and age faster in high temperatures. OLED displays are particularly affected by heat-related aging, and in addition, OLEDs of different colour age differently. This differential ageing of OLEDs of different colours can cause the white point of the display to shift over time. Considerable efforts have been made to control the ageing of OLED displays through active management of temperature, current, and luminance, but heat related ageing remains an issue for all LED displays, and particularly for OLED displays.

### SUMMARY

It is an aim of the present disclosure to provide a method, device and computer readable medium which at least partially address one or more of the challenges discussed above.

According to a first aspect of the present disclosure, there is provided a method for operating a device comprising a LED display, such as an OLED display or a micro-LED display. The method, performed in the device, comprises obtaining a representation of temperatures to which different areas of the display are subjected, generating a display heat map from the obtained representation, and managing the luminance of the different areas of the display on the basis of the display heat map.

According to examples of the present disclosure, the different areas of the display may comprise two or more areas into which the display may be divided. According to examples of the present disclosure, the device may comprise a Wireless Device such as a UE, headphones, watches, smart bands, heads-up or helmet mounted displays etc.

According to examples of the present disclosure, obtaining a representation of temperatures to which different areas of the display are subjected may comprise obtaining temperature readings from one or more temperature sensors positioned relative to the different areas of the display.

According to examples of the present disclosure, obtaining a representation of temperatures to which different areas of the display are subjected may comprise obtaining temperature readings from one or more temperature sensors positioned on at least one component of the display.

According to examples of the present disclosure, the sensors may for example be positioned on a metal coating on a LED panel forming the display, such as the reflecting cathode or anode on the back of an OLED display panel, or in another example on individual pixels of the display.

According to examples of the present disclosure, obtaining a representation of temperatures to which different areas of the display are subjected may comprise obtaining temperature readings from one or more temperature sensors positioned on components adjacent the display.

According to examples of the present disclosure, the device may comprise a Printed Circuit Board, PCB, and obtaining a representation of temperatures to which different areas of the display are subjected may comprise obtaining temperature readings from one or more temperature sensors positioned on components of the printed circuit board.

According to examples of the present disclosure, the PCB may comprise one or more shield cans arranged to at least partially protect components within the shield can from electro-magnetic and radio frequency interference, and obtaining a representation of temperatures to which different areas of the display are subjected may comprise obtaining temperature readings from one or more temperature sensors positioned relative to one or more shield cans. The one or more temperature sensors positioned relative to one or more shield cans may be positioned on an external or internal surface of a shield can, or inside a shield can, for example on a part of the PCB that is contained within the shield can. In some examples, the sensors may comprise thin film thermistors.

According to examples of the present disclosure, generating a display heat map from the obtained representation of temperatures may comprise combining the obtained representation of temperatures with a representation of the physical arrangement of the different areas of the display.

According to examples of the present disclosure, the device may comprise a PCB and the different areas of the display may correspond to areas occupied by different components on the PCB. In some examples, the components on the PCB may be heat generating components responsible at least in part for the temperatures to which the different areas of the display are subjected.

According to examples of the present disclosure, the PCB may comprise one or more shield cans arranged to at least partially protect components within the shield can from electro-magnetic and radio frequency interference, and the different areas of the display may correspond to areas occupied by different shield cans. Such an example may be appropriate if one or more temperature sensors are mounted on or in each shield can, allowing the formation of a heat map in which the physical area corresponding to each shield can is represented by the average temperature recorded by the one or more temperatures mounted on the shield can. This may be an average temperature or the area may be graded to represent different temperatures reported from sensors on different parts of a shield can.

According to examples of the present disclosure, managing the luminance of the different areas of the display on the basis of the display heat map may comprise obtaining a representation of an image to be shown on the display, combining the obtained representation of an image with the generated display heat map, comparing the combined representation of an image and display heat map to an operational specification for pixels of the display, and adjusting the luminance of the pixels of the display as a function of a result of the comparison.

According to examples of the present disclosure, obtaining a representation of an image to be shown on the display may comprise obtaining a representation of required luminance of different pixels of the display to show the image.

According to examples of the present disclosure, combining the obtained representation of an image with the generated display heat map may comprise mapping the required luminance of different pixels of the display to show the image to a required current to be passed through the pixels of the display to generate the required luminance, and generating a combined representation of temperature and required pixel current in the different areas of the display.

According to examples of the present disclosure, combining the obtained representation of an image with the generated display heat map may comprise performing an image blending operation.

According to examples of the present disclosure, comparing the combined representation of an image and display heat map to an operational specification for pixels of the display may comprise comparing the temperature and required pixel current combination for pixels in the combined representation with a maximum temperature and current combination in the operational specification for the pixels.

According to such examples, adjusting the luminance of the pixels of the display as a function of a result of the comparison may comprise: for pixels for which the temperature and required pixel current combination in the combined representation exceed the maximum temperature and current combination in the operational specification, reducing the current to be passed through the pixels such that the maximum temperature and current combination in the operational specification is respected.

According to examples of the present disclosure, the maximum current and temperature combination may comprise a function of current against temperature that defines the maximum operational current for the pixels at different temperature values, the maximum operational current being the current beyond which the expected lifetime of the pixel will be reduced.

According to examples of the present disclosure, reducing the current to be passed through the pixels such that the maximum temperature and current combination in the operational specification is respected may comprise reducing the current by a value that is less than or equal to a maximum reduction value, wherein the maximum reduction value corresponds to a reduction in luminance of the pixels of 30% compared to the required luminance to show the image.

According to examples of the present disclosure, adjusting the luminance of the pixels of the display as a function of a result of the comparison may comprise respecting a maximum rate of change of luminance per pixel row of the display.

According to examples of the present disclosure, the maximum rate of change of luminance per pixel row may comprise 1%.

According to examples of the present disclosure, the method may comprise performing in a first processing unit the steps of: obtaining a representation of temperatures to which different areas of the display are subjected, and generating a display heat map from the obtained representation; and performing in a second processing unit the step of: managing the luminance of the different areas of the display on the basis of the display heat map;

According to examples of the present disclosure, the first processing unit may comprise a Central Processing Unit, CPU, and the second processing unit may comprise at least one of a Graphics Processing Unit, GPU, Video Processing Unit, VPU, or Image Signal Processor, ISP.

According to examples of the present disclosure, the method may comprise performing in a first processing unit the steps of: obtaining a representation of temperatures to which different areas of the display are subjected, generating a display heat map from the obtained representation, and managing the luminance of the different areas of the display on the basis of the display heat map.

According to examples of the present disclosure, the first processing unit may comprise at least one of a CPU and/or an Accelerated Processing Unit, APU.

According to examples of the present disclosure, the display may comprise an OLED display, or a Micro Light Emitting Diode Display.

According to another aspect of the present disclosure, there is provided a computer program comprising instructions which, when executed on at least one processor, cause the at least one processor to carry out a method according to any one of the preceding aspects or examples of the present disclosure.

According to another aspect of the present disclosure, there is provided a carrier containing a computer program according to a preceding aspect of the present disclosure, wherein the carrier comprises one of an electronic signal, optical signal, radio signal or computer readable storage medium.

According to another aspect of the present disclosure, there is provided a computer program product comprising non transitory computer readable media having stored thereon a computer program according to a preceding aspect of the present disclosure.

According to another aspect of the present disclosure, there is provided a device comprising a LED display. The device comprises a processor and a memory, the memory containing instructions executable by the processor such that the device is operable to obtain a representation of temperatures to which different areas of the display are subjected, generate a display heat map from the obtained representation, and manage the luminance of the different areas of the display on the basis of the display heat map.

According to examples of the present disclosure, the device may be further operable to carry out a method according to any one of the preceding aspects or examples of the present disclosure.

According to another aspect of the present disclosure, there is provided a device comprising a LED display. The device is adapted to obtain a representation of temperatures to which different areas of the display are subjected, generate a display heat map from the obtained representation, and manage the luminance of the different areas of the display on the basis of the display heat map.

According to examples of the present disclosure, the device may be further operable to carry out a method according to any one of the preceding aspects or examples of the present disclosure.

According to examples of the present disclosure, a device according to any of the preceding aspects or examples of the present disclosure may further comprise one or more temperature sensors positioned relative to the different areas of the display.

According to examples of the present disclosure, the one or more temperature sensors may be positioned on at least one component of the display.

According to examples of the present disclosure, the one or more temperature sensors may be positioned on a metal coating on a LED panel forming the display, such as the reflecting cathode or anode on the back of an OLED display panel, or in another example on individual pixels of the display.

According to examples of the present disclosure, the one or more temperature sensors may be positioned on components adjacent the display.

According to examples of the present disclosure, the device may further comprise a PCB, and the one or more temperature sensors may be positioned on components of the PCB.

According to examples of the present disclosure, the PCB may comprise one or more shield cans arranged to at least partially protect components within the shield can from electro-magnetic and radio frequency interference, and the one or more temperature sensors may be positioned relative to one or more shield cans. The one or more temperature sensors positioned relative to one or more shield cans may be positioned on an external or internal surface of a shield can, or inside a shield can, for example on a part of the PCB that is contained within the shield can.

According to examples of the present disclosure, the sensors may for example comprise thin film thermistors.

### BRIEF DESCRIPTION OF THE DRAWINGS

For a better understanding of the present invention, and to show more clearly how it may be carried into effect, reference will now be made, by way of example, to the following drawings, in which:

FIG. 1 is a flow chart illustrating process steps in a method for operating a device comprising a LED display;

FIGS. 2a and 2b are flow charts illustrating process steps in another example of a method for operating a device comprising a LED display;

FIG. 3 is an illustration of a PCB for a wireless device;

FIG. 4 is a representation of the structure of an OLED cell;

FIG. 5 is an illustration of a wireless device display corresponding to the wireless device PCB of FIG. 3;

FIG. 6 illustrates a uniformity measurement of luminance of a wireless device display;

FIG. 7 is a graph illustrating an operational specification for an OLED;

FIG. 8 is a block diagram illustrating functional elements in a device;

FIG. 9 is a block diagram illustrating functional elements in another example of a device; and

FIG. 10 is a block diagram illustrating functional elements in another example of a device.

### DETAILED DESCRIPTION

Aspects of the present disclosure provide methods according to which the luminance of different areas of a LED display may be managed on the basis of a display heat map generated from temperatures to which different areas of the display are subjected. Such a heat map may be generated on the basis of readings from temperature sensors placed on or near the backside of the LED display, and may reflect heat generation from an adjacent PCB. The LED display may be an OLED display, or may in some examples be a micro-LED display. Managing luminance of different areas of the display on the basis of the heat map may allow for optimization of the overall lifetime of the display, managing luminance, and hence power through the different areas of the display, to compensate for higher temperatures which may be experienced by the different areas of the display.

Considering the example of a smartphone with an OLED display, device temperature is currently measured at only a few locations in the device and in many cases may not be measured at all on the display side of the device. Temperature compensation for the OLED panel according to existing algorithms is often inefficient in such circumstances, as the display panel is managed on the basis of an average of the device temperature.

This average device temperature does not accurately reflect the true conditions at the display, as different areas of the display panel may be exposed to different temperatures. In addition, smartphone platforms are becoming increasingly powerful with several processing units which may include a Central Processing Unit (CPU), Graphics Processing Unit (GPU), Video Processing Unit (VPU), Image Signal

Processor (ISP, Accelerated Processing Unit (APU) etc. These individual processing units may cause the PCB to generate hotspots, which can be potentially harmful to the adjacent OLED display if high current is run through the pixels above.

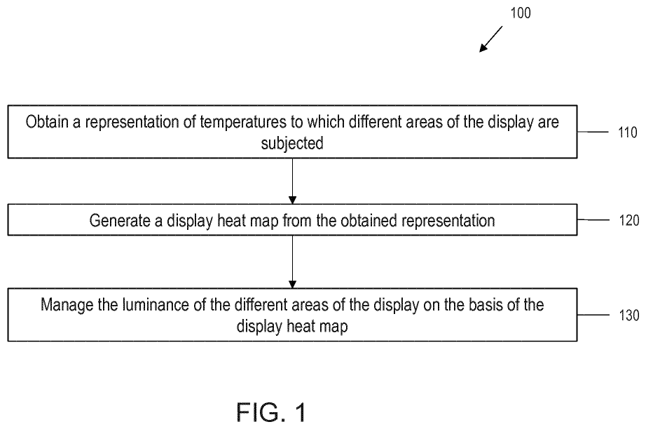

FIG. 1 is a flow chart illustrating process steps in a method 100 for operating a device comprising a LED display. The device may be any electrical device comprising a LED display, including for example a wireless device such as a UE, a watch, a smart band, a HUD or HMD etc. The display may in some examples comprise an OLED display or a micro-LED display. Referring to FIG. 1, the method, which is performed in the device, comprises a first step 110 of obtaining a representation of temperatures to which different areas of the display are subjected. In step 120, the method comprises generating a display heat map from the obtained representation. In step 130, the method comprises managing the luminance of the different areas of the display on the basis of the display heat map. According to different examples, the accuracy with which the display heat map represents the actual temperatures experienced at the display will depend on the accuracy of the representation of temperatures obtained in step 110. The temperatures to which the different areas of the display are subjected may be a result of heat generated by device components adjacent the display, and temperatures measured at these heat generating components may be the representation of temperatures to which the different areas of the screen are subjected. In such examples, temperature representation obtained from as close as possible to the display will provide the most accurate representation of temperatures experienced by the display, and hence the most accurate display heat map.

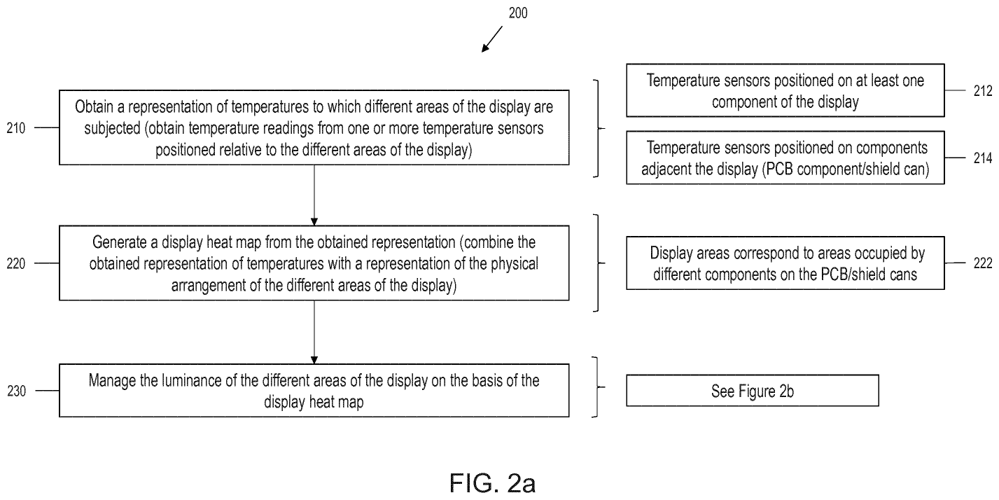

FIGS. 2a and 2b show a flow chart illustrating process steps in another example of method 200 for operating a device comprising a LED display. The steps of the method 200 illustrate one way in which the steps of the method 100 may be implemented and supplemented in order to achieve the above discussed and additional functionality. As for the method of FIG. 1 above, the device operated according to the method 200 may be any electrical device comprising a LED display, including for example a wireless device such as a UE, a watch, a smart band, a HUD or HMD etc. The display may in some examples comprise an OLED display, and the following description of FIGS. 2a and 2b used an OLED display as an illustrative example.

Referring first to FIG. 2a, the method, which is performed in the device, comprises a first step 210 of obtaining a representation of temperatures to which different areas of the display are subjected. The different areas of the display may comprise two or more areas into which the display may be divided. As illustrated in FIG. 2a, this obtaining step may comprise obtaining temperature readings from one or more temperature sensors positioned relative to the different areas of the display. Thin film thermistors are an example of suitable temperature sensors which could be mounted in a volume constrained device such as a smartphone.

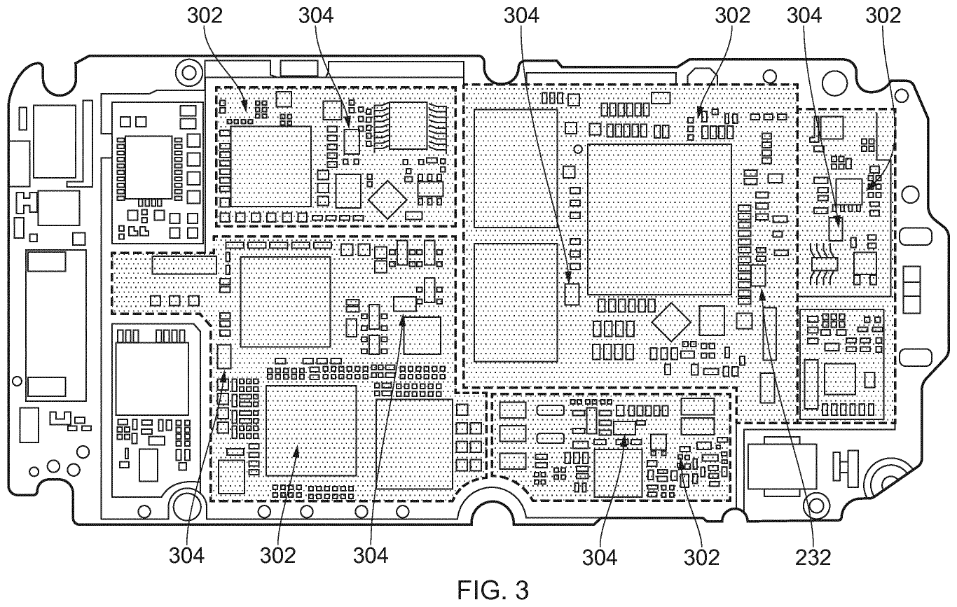

The location of the temperature sensors relative to the display may be chosen according to particular constraints or requirements of a given implementation. As illustrated in step 212, temperature representations may be obtained from one or more temperature sensors positioned on at least one component of the display. As discussed in further detail below with reference to FIG. 4, temperature sensors may be positioned on a metal coating on an OLED panel forming the display, such as the reflecting cathode or anode on the back of an OLED display panel. In another example, temperature sensors may be positioned on individual pixels of the display, although this may have consequences for the operation or design of the pixel, owing to the size constraints to which an OLED pixel is subject. As illustrated in step 214, in another example, temperature representations may be obtained from one or more temperature sensors positioned on components adjacent the display.

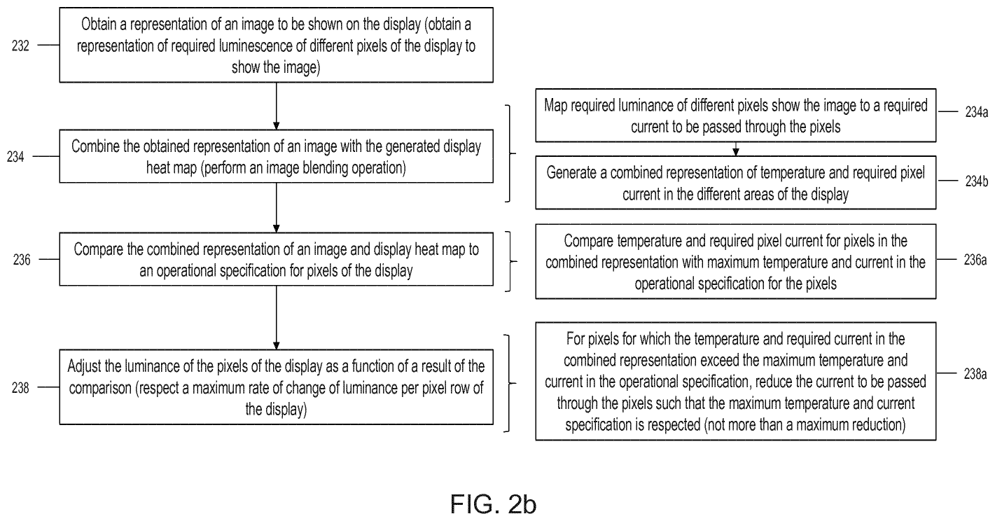

As discussed above, the device performing the method may comprise a Printed Circuit Board (PCB), which may be substantially adjacent to the OLED display, and temperature sensors may be positioned on components of the printed circuit board. A PCB typically comprises one or more shield cans arranged to at least partially protect components within the shield can from electro-magnetic and radio frequency interference, and one or more temperature sensors may be positioned relative to one or more shield cans on the PCB. The one or more temperature sensors positioned relative to one or more shield cans may be positioned on an external or internal surface of a shield can, or inside a shield can, for example on a part of the PCB that is contained within the shield can. This is discussed in further detail below with reference to FIG. 3.

Referring still to FIG. 2a, the method comprises a second step 220 of generating a display heat map from the obtained representation. As illustrated in step 220, this may comprise combining the obtained representation of temperatures with a representation of the physical arrangement of the different areas of the display. As illustrated in step 222, in a device comprising a PCB, the different areas of the display may correspond to areas occupied by different components on the PCB. These components may be heat generating components responsible at least in part for the temperatures to which the different areas of the display are subjected. In a device comprising one or more shield cans, the different areas of the display may correspond to areas occupied by different shield cans. Such an arrangement may be appropriate for example if one or more temperature sensors are mounted on or in each shield can, allowing the formation of a heat map in which the physical area corresponding to each shield can is represented by the average temperature recorded by the one or more temperatures mounted on or in the shield can. This may be a single average temperature or the area may be graded to represent different temperatures reported from sensors on different parts of a shield can.

In step 230, the method 200 comprises managing the luminance of the different areas of the display on the basis of the display heat map. Sub-steps which may be performed in order to achieve this management are illustrated in FIG. 2b.

Referring now to FIG. 2b, the method comprises, in sub-step 232, obtaining a representation of an image to be shown on the display. This may comprise obtaining a representation of required luminance of different pixels of the display to show the image. The representation of required luminance may for example comprise a pixel map indicating required luminance to display the image, or indicating the current required to be passed through the pixels in order to create the required luminance to display the image.

In sub-step 234, the method comprises combining the obtained representation of an image with the generated display heat map. The individual combining sub-steps, discussed below, may be achieved by performing an image blending operation on the heat map and image representation. In sub step 234a, the method comprises mapping the required luminance of different pixels of the display to show the image to a required current to be passed through the pixels of the display to generate the required luminance. This sub-step may be omitted for example if the representation of the image to be displayed is already provided in terms of required current. In sub-step 234b, the method comprises generating a combined representation of temperature and required pixel current in the different areas of the display. The combined representation may provide an indication, at a granularity which may extend from areas of the display to individual display pixels, of the combination of experienced temperature and required current for each part of the display.

In sub-step 236, the method comprises comparing the combined representation of an image and display heat map to an operational specification for pixels of the display. The operational specification may specify maximum current as a function of pixel temperature, so providing an indication of maximum temperature and current combination, to which the temperature and current indicated in the combined representation may be compared, as illustrated in sub-step 236a.

In sub-step 238, the method comprises adjusting the luminance of the pixels of the display as a function of a result of the comparison. In this illustrated example, this adjustment respects a maximum rate of change of luminance per pixel row of the display. An example maximum rate of change of luminance per pixel row may be between 0.5% and 5%, and may in some examples be 1%.

As illustrated in sub-step 238a, the adjusting sub-step may comprise, for pixels for which the temperature and required pixel current combination in the combined representation exceed the maximum temperature and current combination in the operational specification, reducing the current to be passed through the pixels such that the maximum temperature and current combination in the operational specification is respected. As illustrated in sub-step 238a, a maximum current reduction may be imposed, which maximum current reduction may correspond to the maximum luminance reduction which will not adversely impact user experience. For example, a reduction in luminance of up to 30% compared to that originally required to show the image may be substantially undetectable by the human eye, and a maximum current reduction corresponding to a luminance reduction of between 15% and 45% may therefore be applied.

Various aspects of the above presented methods are discussed below in greater detail, with reference to FIGS. 3 to 7.

FIG. 3 is an illustration of a PCB for a smartphone, and demonstrates an example of how temperature sensors may be positioned on the PCB according to aspects of the present disclosure. As discussed above, in order to respect the volume limitations imposed on many electronic devices, thin film thermistors may be used as temperature sensors. In one example, the thermistors may be placed on the PCB in a well distributed manner, with for example a minimum two of thermistors. Placing the thermistors close to the heat generating components may provide a good overview of temperatures experienced by the display, as the size of the heat generating components is known and an estimation may be made that the entire component has the same distributed heat. At least one thermistor in or on each shield can may also provide useful results, as the heat distribution will be contained within one shield can area, thus providing a well-defined limitation for the physical space occupied by the associated hot-spot. Referring to FIG. 3, 5 shield cans 302 can be seen, with each shield can provided with at least one thin film thermistor 304. The area of each shield can may translate to an area or zone on the generated heat map, with the average temperature across the area of the shield can being populated into the area corresponding to the shield can on the heat map. In some cases, a shield can having more than one thermistor may be divided into two areas on the heat map, each area being populated with the temperature of the corresponding thermistor. Thus, referring to FIG. 3, the 5 shield cans may be translated into between 5 and 7 areas on the heat map.

In alternative examples, the temperature sensors, which may comprise thin film thermistors, may be placed on a part of the display itself, for example on a back panel of the display. LED panels usually have a metal coating deposited on the back side of the panel that could be used to transfer the thermistor value to a processor or processing circuitry for generation of the heat map. For connection to the PCB pogo pins or attachment of a Flexible Printed Circuit (FPC) may be used. FIG. 4 illustrates the structure of an example OLED cell comprising a transparent substrate 402 through which light is emitted, a transparent anode 404, a hole transparent layer 406, an emission layer 408, an electron transport layer 410 and a reflecting cathode 412. The reflecting cathode is usually made from Silver (Ag) and so would be a suitable location to mount thermistors to the back side of the OLED cell.

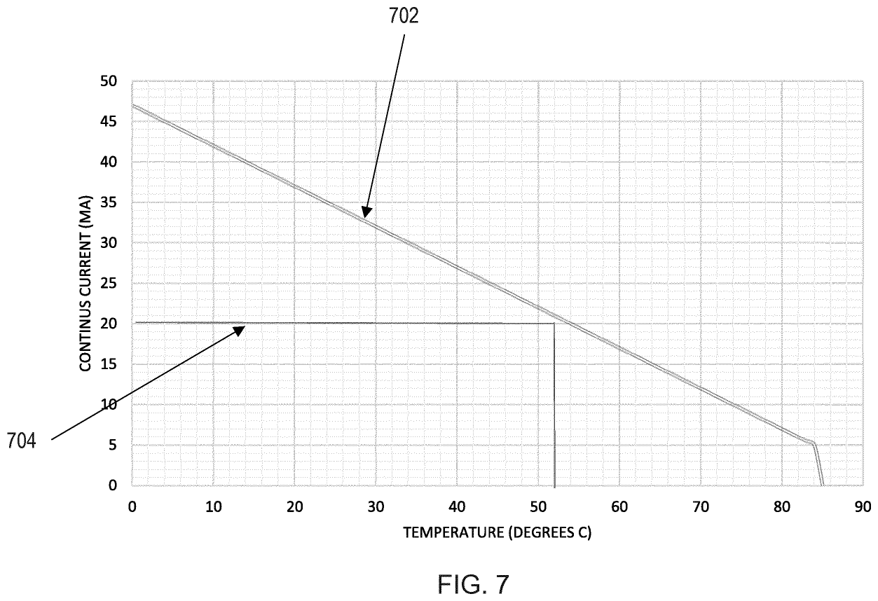

The values of the thermistors are fed back to a processor or processing circuitry where the method is being carried out. This may for example be a CPU, a display driver or other circuitry. As discussed in further detail below with reference to FIG. 8, in some examples, different steps of the method may be conducted in different processing units. The thermistor values are gathered and together with the size and positions of the components close to the thermistors a heat map is generated, which may for example be based on heat areas or zones corresponding to components, as illustrated in FIG. 3.

The generated heat map is then combined with a representation of an image to be shown on the display, for example using an image blending procedure. In areas of the display in which the combination of temperature experienced by the display and current required to show the image exceeds an operating specification for the pixels of the display, the luminance of the display is gradually decreased respect the operating specification. In some examples, the luminance can be lowered up to 30% from the original value. If this is done gradually in an area the human eye is unable to detect the difference. For example, smartphones generally have a uniformity of luminance of between 65% and 80%, and this variation is not visible to the human eye.

In order to avoid an abrupt change in luminance between different areas of the display, it is envisaged that the luminance of the panel may gradually change from normal luminance to lowest luminance at the highest temperature area. The lowest luminance may correspond to a maximum variation that will not affect viewer experience. In some examples this maximum variation may be 30%. In a further examples, the rate of change of luminance across the display may be not greater than 1% per pixel row, meaning a change from 100% luminance to 70% luminance would take place across a minimum of 30 pixel rows. At a pixel density of 440 Pixels per Inch (PPI), this would translate to approximately 2 mm on a standard smartphone.

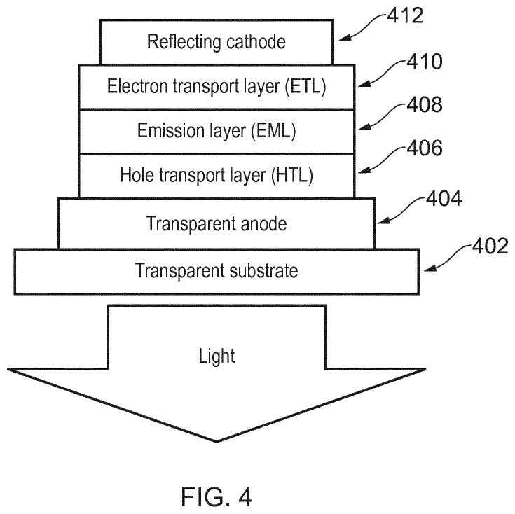

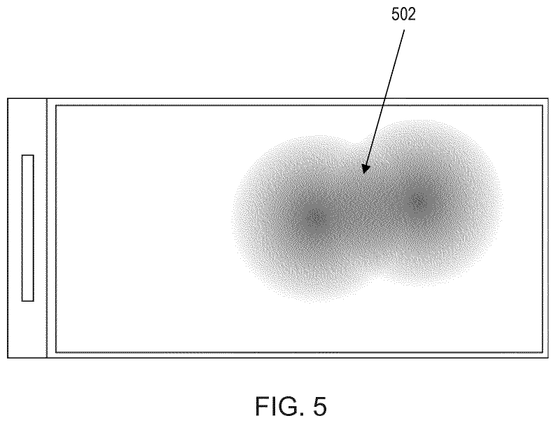

FIG. 5 illustrates an example of area 502 that could be gradually lowered in luminance. The shaded area 502 of FIG. 5 corresponds to the largest shield can 302 on the PCB of FIG. 3. The deepest shading in the area 502 corresponds to a 30% reduction in luminance and the unshaded display corresponds to 100% luminance. The gradual transition from 100% to 70% luminance over the display is illustrated by the gradual darkening of the shading in the area 502. For comparison, FIG. 6 illustrates an example of a uniformity measurement of luminance of a device display, illustrating display luminance uniformity on a standard smartphone. The X and Y axes illustrate display pixels and the Z axis shows luminance intensity level. In contrast to colour variation, to which the human eye is highly sensitive, luminance uniformity is a parameter that the human eye does not detect well, and a luminance reduction in accordance with examples of the present disclosure will not therefore impact user perception of image quality.

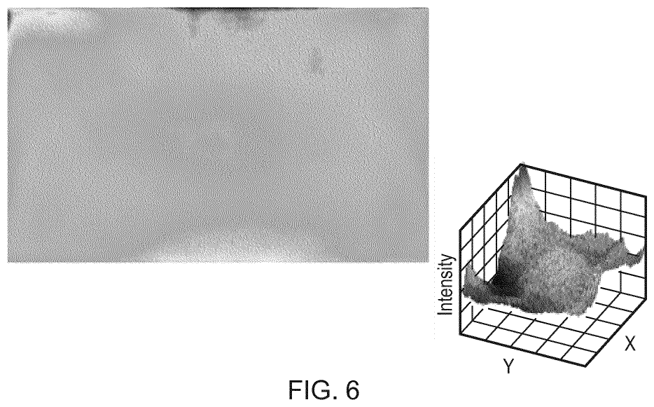

As discussed above, all LEDs age depending on the amount of current that is run through the component. They are specified to a certain lifetime based on a maximum forward current at a certain temperature. FIG. 7 illustrates an operational specification 702 for an OLED pixel, illustrating maximum forward current as a function of temperature. A certain lumen output from the OLED pixel corresponds to a current in mA through the pixel. The current passed through the pixel at different temperatures is linked to a promised lifetime of the OLED pixel. The horizontal line 704 corresponds to a certain lumen at 20 mA current, and in order to respect the operational specification of the pixel, and so benefit from the specified lifetime of the pixel, the temperature of the pixel should not exceed that indicated by the specification 702. If the temperature experienced by the pixel exceeds 54 degrees, the current through the pixel (and hence lumen output) should be decreased in order to stay within the operational specification (under the line 702).

FIG. 8 is a block diagram illustrating functional components of a device 800 that may cooperate to conduct one or more steps of the methods described herein. The device 800 comprises thermistors 810 that supply temperature values to a CPU 830 via an ND converter 820. In one example, the CPU may generate the heat map from the temperature values and a physical layout of the PCB and thermistors retrieved from a memory 860. In other examples, heat map generation may be performed in a GPU 850. If the heat map is generated in the CPU 830, management of the luminance of the display 840 may also be conducted in the CPU, or this may be carried out in a GPU 850. For example, the heat map generated in the CPU 830 may be supplied to the GPU 850, which may then combine the heat map with aa representation of an image to be shown on the display 840 and adjust the luminance of areas of the display according to the combined representation in order to respect an operational specification for the display 840.

Referring back to FIGS. 2a and 2b, the CPU (and/or APU) may conduct steps 210, 220 and 230 (obtaining temperature representations, generating a heat map and managing luminance). In other examples, a CPU or APU may conduct steps 210 and 220 (obtaining temperature representations and generating a heat map), and step 230 (managing luminance) may be conducted in a GPU, VPU and/or ISP.

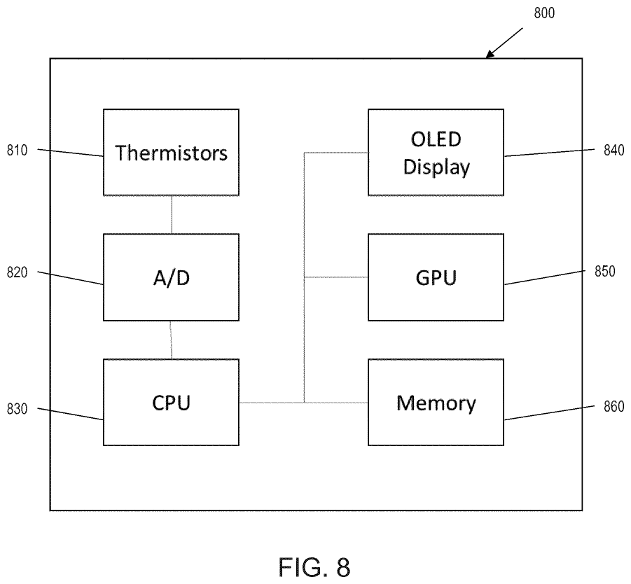

FIG. 9 illustrates another example of device 900, which may implement some or all of the steps of method 100 and/or 200, for example on receipt of suitable instructions from a computer program 950. The device may be any electrical device comprising a LED display, including for example a wireless device such as a UE, a watch, a smart band, a HUD or HMD etc. The display may in some examples comprise an OLED display or a micro-LED display. Referring to FIG. 9, the device 900 comprises a processor or processing circuitry 902, a memory 904 and interfaces 906. The memory 904 contains instructions executable by the processor 902 such that the deice 900 is operative to conduct some or all of the steps of the method 100 and/or 200. The instructions may also include instructions for executing one or more data communications protocols. The instructions may be stored in the form of the computer program 950. In some examples, the processor or processing circuitry 902 may include one or more microprocessors or microcontrollers, as well as other digital hardware, which may include digital signal processors (DSPs), special-purpose digital logic, etc. The processor or processing circuitry 902 may be implemented by any type of integrated circuit, such as an Application Specific Integrated Circuit (ASIC), Field Programmable Gate Array (FPGA) etc. The memory 904 may include one or several types of memory suitable for the processor, such as read-only memory (ROM), random-access memory, cache memory, flash memory devices, optical storage devices, solid state disk, hard disk drive etc.

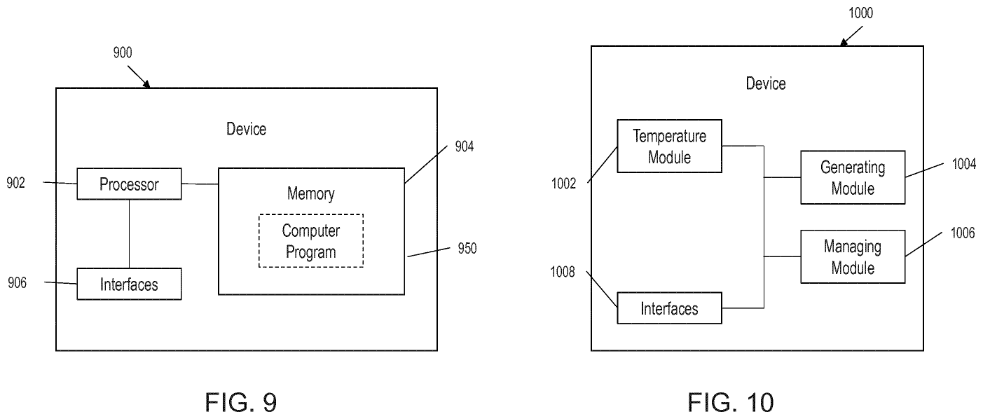

FIG. 10 illustrates another example of device 1000, which may also be any electrical device comprising a LED display, including for example a wireless device such as a UE, a watch, a smart band, a HUD or HMD etc. The display may in some examples comprise an OLED display or a micro-LED display. Referring to FIG. 10, the device 1000 comprises a plurality of functional modules, which may execute some or all of the steps of method 100 and/or 200 on receipt of suitable instructions for example from a computer program. The functional modules of the device 1000 may be realised in any appropriate combination of hardware and/or software. The modules may comprise one or more processors and may be integrated to any degree. The device 100 comprises a temperature module 1002 for obtaining a representation of temperatures to which different areas of the display are subjected. The device further comprises a generating module 1004 for generating a display heat map from the obtained representation and a managing module 1006 for managing the luminance of the different areas of the display on the basis of the display heat map. The device 1000 also comprises interfaces 1008.

Aspects of the present disclosure thus provide methods and apparatus that allow for the management of luminance of different areas of a LED display screen according to the temperatures to which they are subjected. A matrix of thermal sensors may be deployed on a device allowing the generation of a heat map, which may be a differing granularity, to represent the temperatures experienced by different areas of a display. This heat map may then be used to adjust the current through different areas of the display, and in the case of an OLED or micro-LED display through different pixels, to reduce the reduce heat related ageing and so prolong the overall functional life of the display. Thermal sensors may be added to the display itself, for example using the reflective back layer of an OLED panel as signal carrier. It is envisaged that the luminance of a display may be managed such that an imposed reduction in luminance is implemented gradually across the display, so ensuring that the reduction does not affect the viewing experience. The management of the luminance may be dynamic, adapting to the different images that may be shown on the display, and consequently the varying levels of current that are to be run through different parts of the display. An advantage of methods and apparatus according to examples of the present disclosure is that a complete LED display panel may age at substantially the same rate, with hot-spot aging reduced through the active management of luminance. With consistent ageing across a panel, specified lifetimes for the panel components may be achieved, and, in the case of an OLED panel, local white point shift on the display (to which the human eye is highly sensitive) can be avoided.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for operating a device comprising a Light Emitting Diode, LED, display, the method, performed in the device, the method comprising:
obtaining a representation of temperatures to which different areas of the display are subjected;
generating a display heat map from the obtained representation; and
managing the luminance of the different areas of the display on the basis of the display heat map.

2. The method as claimed in claim 1, wherein obtaining a representation of temperatures to which different areas of the display are subjected comprises obtaining temperature readings from one or more temperature sensors positioned relative to the different areas of the display.

3. The method as claimed in claim 1, wherein obtaining a representation of temperatures to which different areas of the display are subjected comprises obtaining temperature readings from one or more temperature sensors positioned on at least one component of the display.

4. The method as claimed in claim 1, wherein obtaining a representation of temperatures to which different areas of the display are subjected comprises obtaining temperature readings from one or more temperature sensors positioned on components adjacent the display.

5. The method as claimed in claim 4, wherein the device comprises a Printed Circuit Board, PCB, and wherein obtaining a representation of temperatures to which different areas of the display are subjected comprises obtaining temperature readings from one or more temperature sensors positioned on components of the printed circuit board.

6. The method as claimed in claim 5, wherein the PCB comprises one or more shield cans arranged to at least partially protect components within the shield can from electro-magnetic and radio frequency interference, and wherein obtaining a representation of temperatures to which different areas of the display are subjected comprises obtaining temperature readings from one or more temperature sensors positioned relative to one or more shield cans.

7. The method as claimed in claim 1, wherein generating a display heat map from the obtained representation of temperatures comprises combining the obtained representation of temperatures with a representation of the physical arrangement of the different areas of the display.

8. The method as claimed in claim 7, wherein the device comprises a Printed Circuit Board, PCB, and wherein the different areas of the display correspond to areas occupied by different components on the PCB.

9. The method as claimed in claim 8, wherein the PCB comprises one or more shield cans arranged to at least partially protect components within the shield can from electro-magnetic and radio frequency interference, and wherein the different areas of the display correspond to areas occupied by different shield cans.

10. The A method as claimed in claim 1, wherein managing the luminance of the different areas of the display on the basis of the display heat map comprises:
obtaining a representation of an image to be shown on the display;
combining the obtained representation of an image with the generated display heat map;
comparing the combined representation of an image and display heat map to an operational specification for pixels of the display; and
adjusting the luminance of the pixels of the display as a function of a result of the comparison.

11. The method as claimed in claim 10, wherein obtaining a representation of an image to be shown on the display comprises obtaining a representation of required luminance of different pixels of the display to show the image.

12. The method as claimed in claim 11, wherein combining the obtained representation of an image with the generated display heat map comprises:
mapping the required luminance of different pixels of the display to show the image to a required current to be passed through the pixels of the display to generate the required luminance; and
generating a combined representation of temperature and required pixel current in the different areas of the display.

13. The method as claimed in claim 11, wherein combining the obtained representation of an image with the generated display heat map comprises performing an image blending operation.

14. The A method as claimed in claim 12, wherein comparing the combined representation of an image and display heat map to an operational specification for pixels of the display comprises:
comparing the temperature and required pixel current combination for pixels in the combined representation with a maximum temperature and current combination in the operational specification for the pixels;
and wherein adjusting the luminance of the pixels of the display as a function of a result of the comparison comprises:
for pixels for which the temperature and required pixel current combination in the combined representation exceed the maximum temperature and current combination in the operational specification, reducing the current to be passed through the pixels such that the maximum temperature and current combination in the operational specification is respected.

15. The method as claimed in claim 14, wherein reducing the current to be passed through the pixels such that the maximum temperature and current combination in the operational specification is respected comprises reducing the current by a value that is less than or equal to a maximum reduction value, wherein the maximum reduction value corresponds to a reduction in luminance of the pixels of 30% compared to the required luminance to show the image.

16. The method as claimed in any one of claims 10, wherein adjusting the luminance of the pixels of the display as a function of a result of the comparison comprises respecting a maximum rate of change of luminance per pixel row of the display.

17. The method as claimed in claim 16, wherein the maximum rate of change of luminance per pixel row comprises 1%.

18. (canceled)

19. (canceled)

20. The method as claimed in claim 1, further comprising, in a first processing unit:
obtaining a representation of temperatures to which different areas of the display are subjected;
generating a display heat map from the obtained representation; and
managing the luminance of the different areas of the display on the basis of the display heat map.

21. (canceled)

22. (canceled)

23. A computer storage medium storing computer program comprising instructions which, when executed on at least one processor, cause the at least one processor to carry out a method for operating a device comprising a Light Emitting Diode, LED, display, the method comprising:
obtaining a representation of temperatures to which different areas of the display are subjected;
generating a display heat map from the obtained representation; and
managing the luminance of the different areas of the display on the basis of the display heat map.

24. (canceled)

25. (canceled)

26. A device comprising a Light Emitting Diode, LED, display, the device comprising a processor and a memory, the memory containing instructions executable by the processor such that the device is configured to:
obtain a representation of temperatures to which different areas of the display are subjected;
generate a display heat map from the obtained representation; and
manage the luminance of the different areas of the display on the basis of the display heat map.

27.-34. (canceled)
